(19) United States
(12) Patent Application Publication
(10) Pub. No.: US 2025/0392080 A1
(43) Pub. Date: Dec. 25, 2025

(54) TERMINAL MODULE AND BACKPLANE CONNECTOR HAVING BUMP PORTION FOR ADJUSTING IMPEDANCE

(71) Applicant: DONGGUAN LUXSHARE TECHNOLOGIES CO., LTD, Dongguan City (CN)

(72) Inventors: Tao SONG, Dongguan City (CN); Kun LIU, Dongguan City (CN); Xiaoping WU, Dongguan City (CN)

(73) Assignee: DONGGUAN LUXSHARE TECHNOLOGIES CO., LTD, Dongguan City (CN)

(21) Appl. No.: 18/901,956

(22) Filed: Sep. 30, 2024

(30) Foreign Application Priority Data
Jun. 25, 2024 (CN) 202421467351.9

(51) Int. Cl. H01R 13/6581; H01R 12/73

(52) U.S. Cl. CPC H01R 13/6581; H01R 12/737

(57) ABSTRACT

A terminal module includes a number of conductive terminals, an insulating block and a metal shield surrounding member. The conductive terminal includes a contact portion. The insulating block is sleeved on the contact portion. The metal shield surrounding member is sleeved on the insulating block. The metal shield surrounding member includes an inner cavity. The insulating block is at least partially received in the inner cavity. The metal shield surrounding member is provided with at least one bump portion protruding into the inner cavity. The bump portion is configured to adjust the impedance of a signal terminal pair.

### CROSS-REFERENCE TO RELATED APPLICATION

This patent application claims priority of a Chinese Patent Application No. 202421467351.9, filed on Jun. 25, 2024 and titled “TERMINAL MODULE AND BACKPLANE CONNECTOR”, the entire content of which is incorporated herein by reference.

### TECHNICAL FIELD

The present disclosure relates to a terminal module and a backplane connector, which belong to the technical field of connectors.

### BACKGROUND

The existing backplane connector usually includes a header and a plurality of terminal modules mounted to the header. Each terminal module includes an insulating frame, a plurality of conductive terminals insert-molded with the insulating frame, and a metal shield installed on at least one side of the insulating frame. The conductive terminals generally include several groups of signal terminal pairs and a plurality of ground terminals located on both sides of each group of signal terminal pair.

Each signal terminal pair generally includes a first signal terminal and a second signal terminal. However, how to adjust the impedance of the first signal terminal and the second signal terminal is crucial to improve the quality of signal transmission.

### SUMMARY

An object of the present disclosure is to provide a terminal module and a backplane connector which are beneficial to adjust impedance.

In order to achieve the above object, the present disclosure adopts the following technical solution: a terminal module, including: a plurality of conductive terminals, each conductive terminal including a contact portion; the plurality of conductive terminals including a first signal terminal and a second signal terminal, the first signal terminal and the second signal terminal forming a signal terminal pair; an insulating block, the insulating block being sleeved on the contact portion of the first signal terminal and the contact portion of the second signal terminal; and a metal shield surrounding member, the metal shield surrounding member being sleeved on the insulating block; the metal shield surrounding member including a first side wall, a second side wall, a third side wall and a fourth side wall; the first side wall being opposite to the third side wall; the second side wall being opposite to the fourth side wall; the metal shield surrounding member defining an inner cavity surrounded by the first side wall, the second side wall, the third side wall and the fourth side wall; the insulating block being at least partially received in the inner cavity; wherein the metal shield surrounding member is provided with at least one bump portion protruding into the inner cavity and exposed in the inner cavity; the bump portion is configured to adjust impedance of the signal terminal pair.

In order to achieve the above object, the present disclosure adopts the following technical solution: a backplane connector, including: a header, the header defining a receiving space configured to receive a mating backplane connector and a plurality of terminal receiving grooves which extend through the header and communicate with the receiving space; and a plurality of terminal modules assembled to the header; at least one of the terminal modules including: a plurality of conductive terminals, each conductive terminal including a contact portion; the plurality of conductive terminals including a first signal terminal and a second signal terminal, the first signal terminal and the second signal terminal forming a signal terminal pair; an insulating block, the insulating block being at least partially shielding the contact portion of the first signal terminal and the contact portion of the second signal terminal; and a metal shield surrounding member, the metal shield surrounding member being at least partially shielding the insulating block; the metal shield surrounding member including a first side wall, a second side wall, a third side wall and a fourth side wall; the first side wall being opposite to the third side wall; the second side wall being opposite to the fourth side wall; the metal shield surrounding member defining an inner cavity enclosed by the first side wall, the second side wall, the third side wall and the fourth side wall; the insulating block being at least partially received in the inner cavity; wherein the metal shield surrounding member is provided with at least one bump portion protruding into the inner cavity and exposed in the inner cavity; the bump portion is configured to adjust impedance of the signal terminal pair; wherein the metal shield surrounding member passes through a corresponding terminal receiving groove so as to extend into the receiving space.

Compared with the prior art, the metal shield surrounding member of the present disclosure is provided with at least one bump portion protruding into the inner cavity and exposed in the inner cavity. The bump portion is configured to adjust impedance of the signal terminal pair. When signal terminals of the mating backplane connector are separated from the contact portions of the signal terminal pair, the bump portion is able to suppress the impedance of the signal terminal, thereby playing a role of adjusting the impedance.

### BRIEF DESCRIPTION OF DRAWINGS

FIG. 1 is a perspective view of a backplane connector assembly in accordance with an embodiment of the present disclosure;

FIG. 2 is a partially exploded perspective view of FIG. 1;

FIG. 3 is a perspective schematic view of a backplane connector installed on a first circuit board in accordance with an embodiment of the present disclosure;

FIG. 4 is a partially exploded perspective view of FIG. 3;

FIG. 5 is a partial perspective exploded view of the backplane connector in FIG. 4 from another angle;

FIG. 6 is a front view of the backplane connector in FIG. 3;

FIG. 7 is a partial perspective exploded view of the backplane connector after removing a header in FIG. 5, in which a spacer is separated;

FIG. 8 is a side view of a terminal module of the backplane connector;

FIG. 9 is a partial perspective exploded view of the backplane connector from another angle;

FIG. 10 is a partial enlarged view of a circled part A in FIG. 9;

FIG. 11 is a perspective schematic view of the terminal module of the backplane connector;

FIG. 12 is a partially exploded perspective view of FIG. 11;

FIG. 13 is a side view of a first metal shield of the backplane connector;

FIG. 14 is a side view of a second metal shield of the backplane connector;

FIG. 15 is a side view of FIG. 11 after the first metal shield and the second metal shield are removed, in which a metal shield surrounding member and an insulating block are separated;

FIG. 16 is a perspective sectional view taken along line K-K in FIG. 2;

FIG. 17 is a partial enlarged view of a frame part B in FIG. 16;

FIG. 18 is a partial perspective exploded view of conductive terminals in the terminal module;

FIG. 19 is a front view of FIG. 18;

FIG. 20 is a partial enlarged view of a circled part C in FIG. 18;

FIG. 21 is a partial enlarged view of a circled part D in FIG. 19;

FIG. 22 is a partial enlarged view of FIG. 21 from another angle;

FIG. 23 is a perspective exploded view of the metal shield surround and the insulating block;

FIG. 24 is an exploded perspective view of FIG. 23 from another angle;

FIG. 25 is an exploded perspective view of FIG. 24 from another angle;

FIG. 26 is a top view of FIG. 24;

FIG. 27 is a schematic cross-sectional view taken along line E-E in FIG. 3;

FIG. 28 is a schematic cross-sectional view taken along line F-F in FIG. 3;

FIG. 29 is a partial enlarged view of a frame part H in FIG. 27; and

FIG. 30 is a partial enlarged view of a frame part I in FIG. 28.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

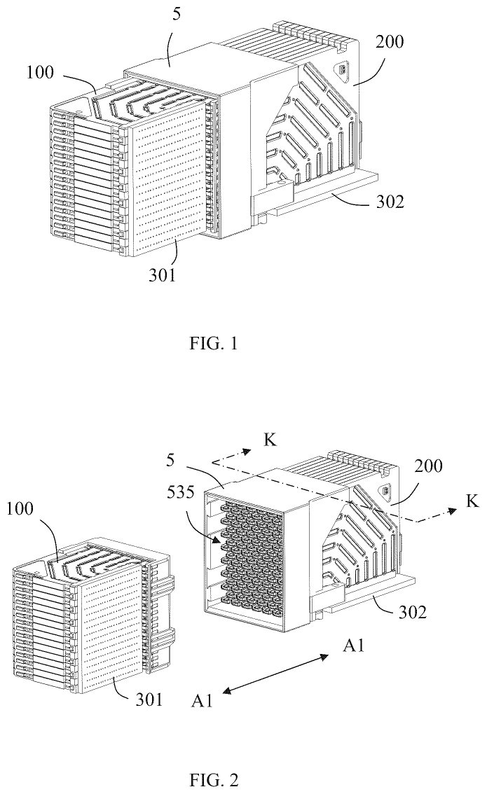

Referring to FIGS. 1 and 2, the present disclosure discloses a backplane connector assembly including a backplane connector 200, a mating backplane connector 100 mateable with the backplane connector 200, a first circuit board 302 mounted with the backplane connector 200, and a second circuit board 301 mounted with the mating backplane connector 100. In the illustrated embodiment of the present disclosure, the backplane connector 200 and the mating backplane connector 100 are mated in an orthogonal manner. The second circuit board 301 is perpendicular to the first circuit board 302.

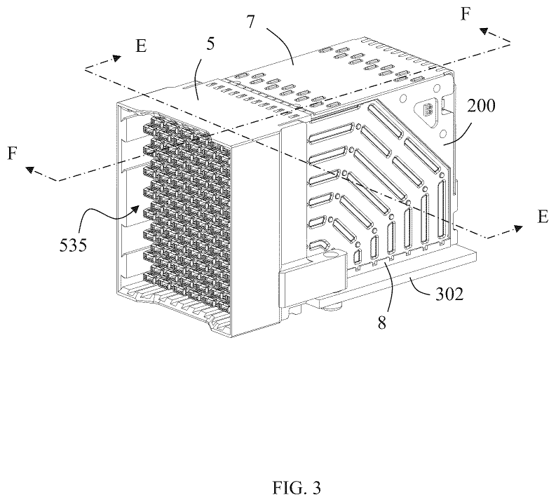

Referring to FIG. 3, in the illustrated embodiment of the present disclosure, the backplane connector 200 is fixed to the first circuit board 302 by a bolt 303. The backplane connector 200 is adapted for mating with the mating backplane connector 100 for high-speed data transmission.

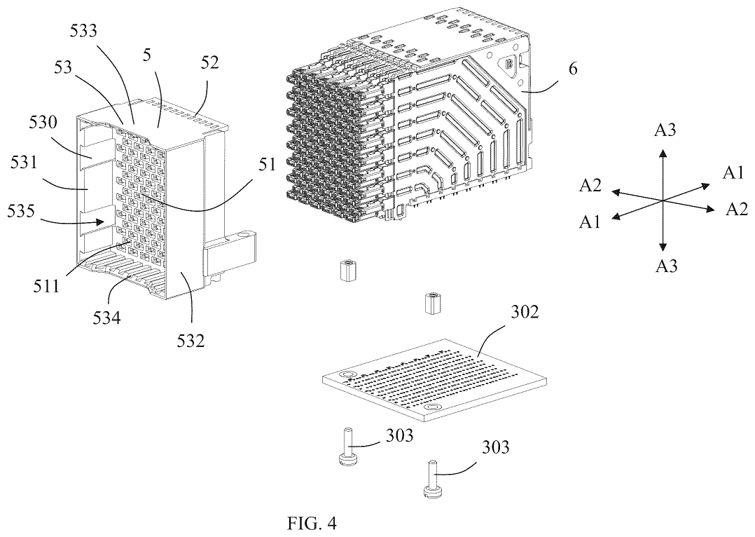

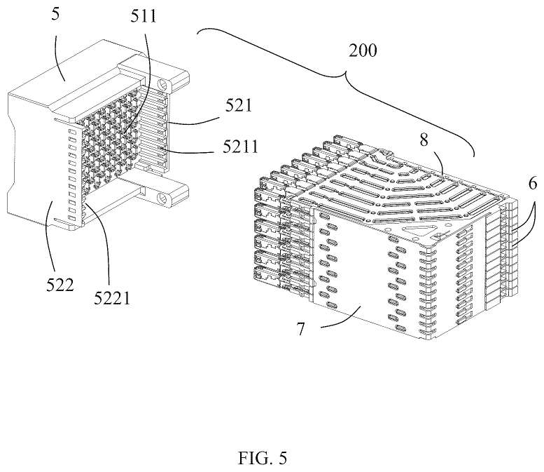

Referring to FIGS. 4 and 5, the backplane connector 200 includes a header 5, a plurality of terminal modules 6 assembled to the header 5, a spacer 7 holding on one side of the plurality of terminal modules 6, and a mounting block 8 holding the other side of the plurality of terminal modules 6.

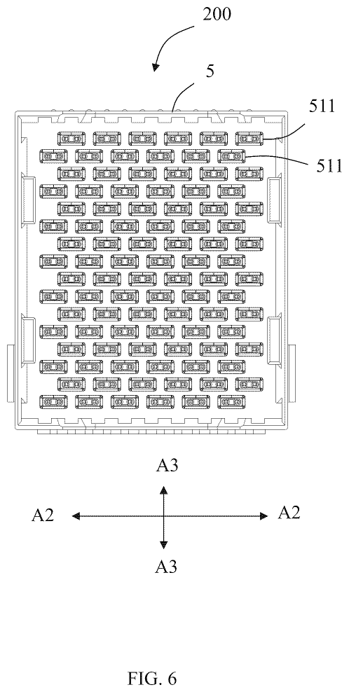

The header 5 is made of insulating material. The header 5 includes a body portion 51, a wall portion 52 extending from the body portion 51 to one end (for example, extending forwardly), and a frame portion 53 extending from the body portion 51 to the other end (for example, extending backwardly). The body portion 51 includes a plurality of terminal receiving grooves 511 extending along a first direction A1-A1 (for example, a front-rear direction). It is understandable to those skilled in the art that the first direction A1-A1 is an insertion and extraction direction of the backplane connector 200 and the mating backplane connector 100. Referring to FIG. 6, in the illustrated embodiment of the present disclosure, the terminal receiving grooves 511 are disposed in multiple rows along a second direction A2-A2 (for example, a left-right direction). Two adjacent rows of terminal receiving grooves 511 are staggered in a third direction A3-A3 (for example, a top-bottom direction). That is, in two adjacent rows of the terminal receiving grooves 511, the terminal receiving grooves 511 at corresponding positions are not in alignment with each other in the second direction A2-A2. The wall portion 52 includes a first wall portion 521 and a second wall portion 522 disposed opposite to each other. The first wall portion 521 includes a plurality of first slots 5211. The second wall portion 522 includes a plurality of second slots 5221. The first slot 5211 and the second slot 5221, which are in alignment with each other, together with the terminal receiving groove 511 corresponding to the first slot 5211 and the second slot 5221 are jointly used for receiving the same terminal module 6.

The frame portion 53 includes a first extension wall 531, a second extension wall 532 opposite to the first extension wall 531, a top wall 533 connecting one end of the first extension wall 531 and one end of the second extension wall 532, a bottom wall 534 connecting the other end of the first extension wall 531 and the other end of the second extension wall 532, and a receiving space 535 jointly enclosed by the first extension wall 531, the second extension wall 532, the top wall 533 and the bottom wall 534. The receiving space 535 is used for at least partially accommodating the mating backplane connector 100. Specifically, in the illustrated embodiment of the present disclosure, both the first extension wall 531 and the second extension wall 532 include a plurality of positioning grooves 530 in order to improve the mating accuracy of the mating backplane connector 100 and the backplane connector 200.

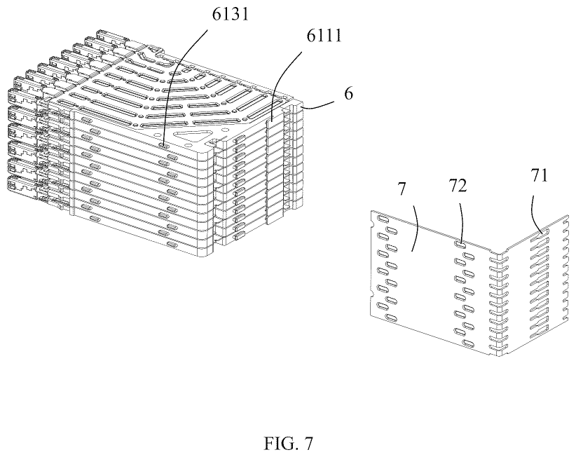

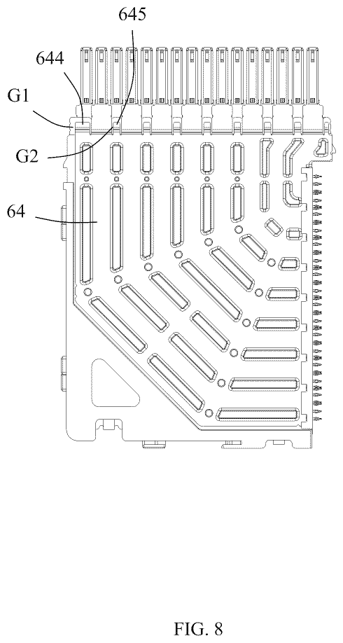

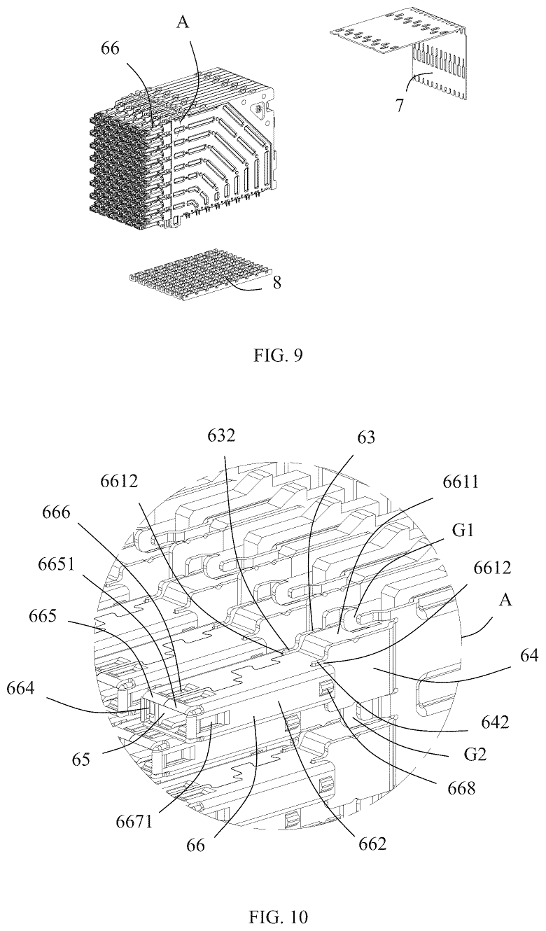

Referring to FIGS. 7 to 12, each terminal module 6 includes an insulating frame 61, a plurality of conductive terminals 62 insert-molded with the insulating frame 61, a first metal shield 63 fixed on one side of the insulating frame 61, and a second metal shield 64 fixed on the other side of the insulating frame 61.

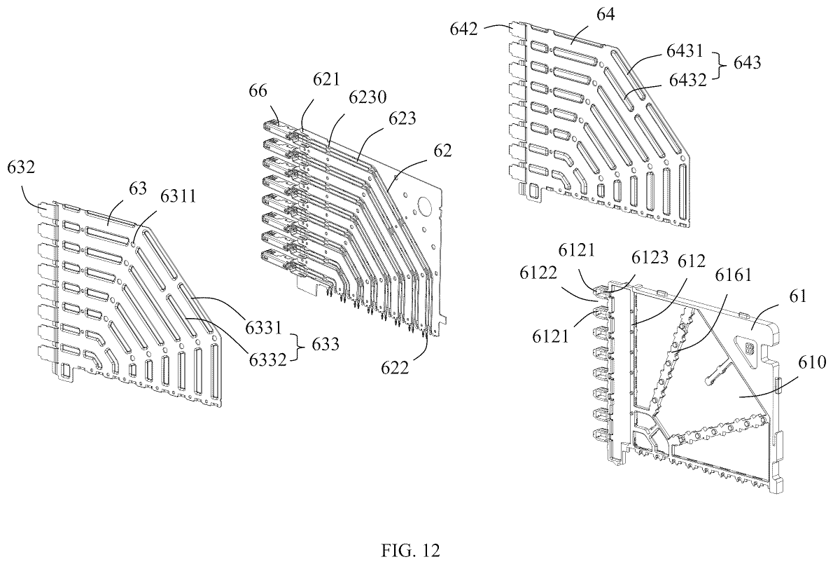

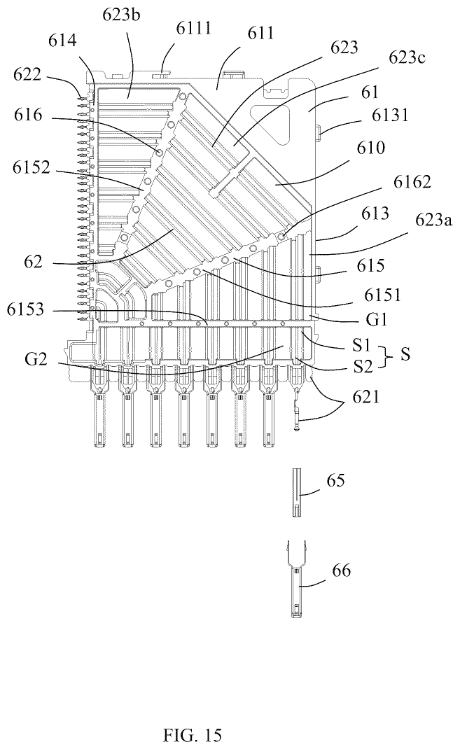

Referring to FIGS. 12 and 15, the insulating frame 61 is roughly frame-shaped. Each insulating frame 61 includes a rear wall 611, a front wall 612 opposite to the rear wall 611, a top wall 613 connecting one end of the rear wall 611 and one end of the front wall 612, a bottom wall 614 connecting the other end of the rear wall 611 and the other end of the front wall 612, and a plurality of connecting walls 615. The connecting walls 615 can enhance the structural strength of the frame. The rear wall 611 includes a first protrusion 6111. The top wall 613 includes a second protrusion 6131. Referring to FIG. 5, the spacer 7 is roughly L-shaped and includes a plurality of first slots 71 and a plurality of second slots 72 for holding the first protrusions 6111 and the second protrusions 6131, respectively. With this arrangement, each terminal module 6 can be formed as a whole by providing the spacer 7. In the illustrated embodiment of the present disclosure, the insulating frame 61 includes a hollow portion 610. The connecting walls 615 include a first connecting wall 6151 connecting the top wall 613 and the bottom wall 614, and a second connecting wall 6152 connecting the rear wall 611 and the bottom wall 614. The first connecting wall 6151 and the second connecting wall 6152 are exposed in the hollow portion 610. The first connecting wall 6151 and the second connecting wall 6152 are disposed obliquely. One ends of the first connecting wall 6151 and the second connecting wall 6152 are adjacent to each other, and the other ends are spread out so as to form a radial shape. The connecting walls 615 also includes a reinforcing wall 6153 connecting the top wall 613 and the bottom wall 614 and parallel to the front wall 612.

Referring to FIGS. 12 and 15, the front wall 612 includes a plurality of protruding blocks 6121 disposed at intervals and a groove 6122 located between two adjacent protruding blocks 6121. The protruding block 6121 includes an opening 6123 to partially expose corresponding conductive terminal 62 in order to adjust the impedance.

The insulating frame 61 further includes a plurality of posts 616 for fixing and positioning the first metal shield 63 and the second metal shield 64. In the illustrated embodiment of the present disclosure, the posts 616 are substantially cylindrical-shaped. In the illustrated embodiment of the present disclosure, the posts 616 are disposed on the bottom wall 614, the first connecting wall 6151 and the second connecting wall 6152. The first metal shield 63 and the second metal shield 64 are located on two sides of the insulating frame 61, respectively. The posts 616 include a plurality of first posts 6161 and a plurality of second posts 6162. The first posts 6161 and the second posts 6162 are located on opposite sides of the insulating frame 61 so to be fixed to the first metal shield 63 and the second metal shield 64, respectively.

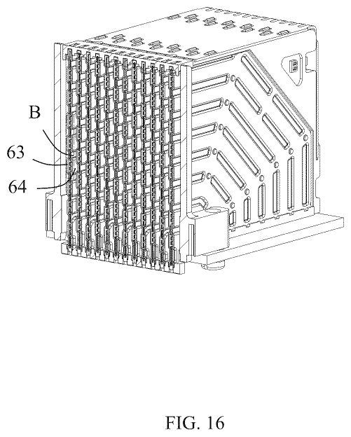

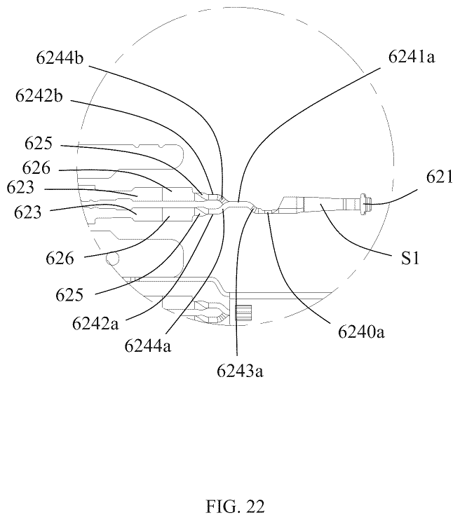

Referring to FIGS. 16 to 22, in the illustrated embodiment of the present disclosure, each group of conductive terminals 62 include a contact portion 621, a tail portion 622 and a connection portion 623 located between the contact portion 621 and the tail portion 622. The mounting block 8 includes a plurality of through holes for the tail portions 622 to pass through, so as to facilitate the positioning of each tail portion 622. This facilitates the mounting of the tail portions 622 to the first circuit board 302. Some of the contact portions 621 are used to electrically connect with the mating backplane connector 100. In the illustrated embodiment of the present disclosure, the connection portion 623 is curved. Specifically, the connection portion 623 includes a first section 623a parallel to the contact portion 621, a second section 623b parallel to the tail portion 622, and a third section 623c connecting the first section 623a and the second section 623b. Referring to FIG. 15, the first section 623a extends vertically, the second section 623b extends horizontally, and the third section 623c extends obliquely.

Each group of conductive terminals 62 include a plurality of first ground terminals G1, a plurality of second ground terminals G2, and a plurality of signal terminals S. The plurality of signal terminals S include a plurality of first signal terminals S1 and a plurality of second signal terminals S2. In the illustrated embodiment of the present disclosure, the adjacent first signal terminal S1 and the second signal terminal S2 form signal terminal pair, for example a differential pair. Each pair of signal terminal pair are located between one first ground terminal G1 and one second ground terminal G2. That is, each group of conductive terminals 62 are disposed in a manner of G1-S1-S2-G2, which is beneficial to improve the quality of signal transmission. The signal terminal pair are coupled through narrow-side coupling and wide-side coupling. A width of the first ground terminal G1 and a width of the second ground terminal G2 are greater than a width of each first signal terminal S1 and a width of each second signal terminal S2 therebetween, which is beneficial to increase the shielding area and improve the shielding effect.

In the illustrated embodiment of the present disclosure, the connection portions 623 of the conductive terminals 62 are insert-molded with the insulating frame 61. The connection portions 623 of the signal terminal pair, the connection portion 623 of the first ground terminal G1 and the connection portion 623 of the second ground terminal G2 are all exposed in the same hollow portion 610. The connection portion 623 of the signal terminal S includes a narrowed portion 6230 (referring to FIG. 12) embedded in the insulating frame 61 to adjust the impedance of the signal terminal S in order to achieve impedance matching.

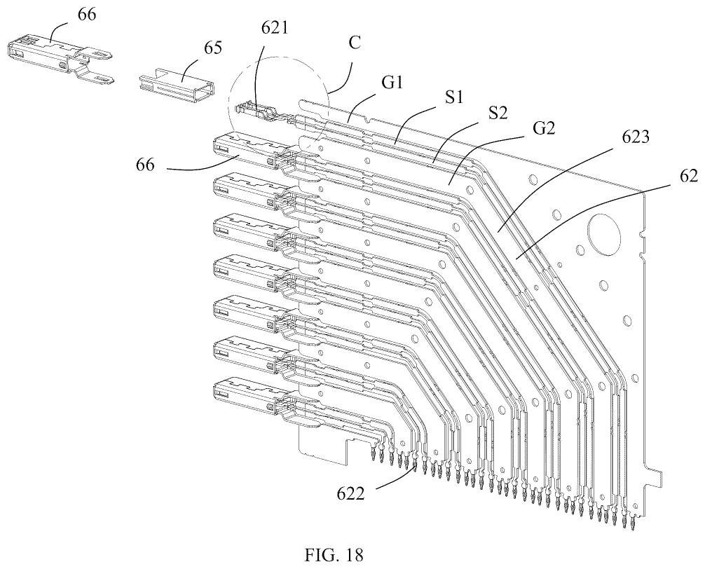

Referring to FIGS. 18 to 22, in the illustrated embodiment of the present disclosure, the signal terminal pair further includes a first extending portion 624 extending from the contact portion 621 of the signal terminal pair toward the connection portion 623 of the signal terminal pair, a torsion portion 625 connected to the first extending portion 624, and a second extending portion 626 connected to the torsion portion 625. The first extending portion 624, the torsion portion 625 and the second extending portion 626 extend along the first direction A1-A1 (for example, the front-rear direction). The first extending portion 624 includes a wide side and a narrow side. The second extending portion 626 includes a wide side and a narrow side. The first extending portion 624 of the first signal terminal S1 and the first extending portion 624 of the second signal terminal S2 are arranged side by side, and spaced apart from each other along the second direction A2-A2 (for example, the left-right direction). The narrow side of the first extending portion 624 of the first signal terminal S1 is coupled with the narrow side of the first extending portion 624 of the second signal terminal S2. The second extending portion 626 of the first signal terminal S1 and the second extending portion 626 of the second signal terminal S2 are spaced apart from each other along the third direction A3-A3 (for example, the top-bottom direction). The narrow side of the second extending portion 626 of the first signal terminal S1 is coupled with the narrow side of the second extending portion 626 of the second signal terminal S2. Compared with the first extending portion 624 and the second extending portion 626 at opposite ends of the torsion portion 625, the torsion portion 625 is in a contracted manner, which is beneficial to reduce the resistance when twisting to form the torsion portion 625 and reduce the manufacturing difficulty. In addition, this arrangement is also beneficial to make the torsion area where the torsion portion 625 is located as short as possible, thereby improving the coupling effect of the first signal terminal S1 and the second signal terminal S2. By providing the torsion portion 625, the second extending portion 626 is substantially perpendicular to the first extending portion 624.

Specifically, the first extending portion 624 of the first signal terminal S1 includes a first bottom surface 6240a, a first step surface 6241a higher than the first bottom surface 6240a, a first extension surface 6242a lower than the first step surface 6241a, a first inclined portion 6243a connecting the first bottom surface 6240a and the first step surface 6241a, and a first bending portion 6244a connecting the first step surface 6241a and the first extension surface 6242a.

The first extending portion 624 of the second signal terminal S2 includes a second bottom surface 6240b, a second step surface 6241b higher than the second bottom surface 6240b, a second extension surface 6242b higher than the second step surface 6241b, a second inclined portion 6243b connecting the second bottom surface 6240b and the second step surface 6241b, and a second bending portion 6244b connecting the second step surface 6241b and the second extension surface 6242b.

In the illustrated embodiment of the present disclosure, the contact portion 621, the first bottom surface 6240a, the first inclined portion 6243a and the first step surface 6241a of the first signal terminal S1 are in one-to-one correspondence with the contact portion 621, the second bottom surface 6240b, the second inclined portion 6243b and the second step surface 6241b of the second signal terminal S2, respectively. The contact portion 621, the first bottom surface 6240a, the first inclined portion 6243a and the first step surface 6241a of the first signal terminal S1 have the same structure and are arranged in alignment along the second direction A2-A2 with respect to the corresponding contact portion 621, the corresponding second bottom surface 6240b, the corresponding second inclined portion 6243b and the corresponding second step surface 6241b of the second signal terminal S2. A plane P where the first step surface 6241a and the second step surface 6241b are located is located between a plane where the first extension surface 6242a is located and a plane where the second extension surface 6242b is located. In other words, the first extension surface 6242a is upwardly higher than the first step surface 6241a and the second step surface 6241b. The second extension surface 6242b is downwardly lower than the first step surface 6241a and the second step surface 6241b. Preferably, the first bending portion 6244a, the first extension surface 6242a, the torsion portion 625 and the second extending portion 626 of the first signal terminal S1, and the second bending portion 6244b, the second extension surface 6242b, the torsion portion 625 and the second extending portion 626 of the second signal terminal S2 are symmetrically arranged along the plane P where the first step surface 6241a and the second step surface 6241b are located. This arrangement is beneficial to make the structures and lengths of the first signal terminal S1 and the second signal terminal S2 closer, thereby helping to improve impedance matching. Each of the first extension surface 6242a and the second extension surface 6242b includes a wide side and a narrow side. The wide side of the first extension surface 6242a is coupled with the wide side of the second extension surface 6242b. In the illustrated embodiment of the present disclosure, the torsion portion 625 of the first signal terminal S1 and the torsion portion 625 of the second signal terminal S2 have the same torsion angle. This arrangement facilitates the use of a clamp to tort the first signal terminal S1 and the second signal terminal S2 simultaneously, thereby improving production efficiency.

In the present disclosure, the first extending portion 624 and the second extending portion 626 of the first signal terminal S1 and the second signal terminal S2 are perpendicular to each other. The first bottom surface 6240a, the first inclined portion 6243a and the first step surface 6241a of the first signal terminal S1 are in one-to-one correspondence with the second bottom surface 6240b, the second inclined portion 6243b and the second step surface 6241b of the second signal terminal S2, respectively. The first bottom surface 6240a, the first inclined portion 6243a and the first step surface 6241a of the first signal terminal S1, and the corresponding second bottom surface 6240b, the corresponding second inclined portion 6243b and the corresponding second step surface 6241b of the second signal terminal S2 have the same structure and are coupled through narrow sides. The second extending portion 626 of the first signal terminal S1 corresponds to the second extending portion 626 of the second signal terminal S2. The second extending portion 626 of the first signal terminal S1 and the second extending portion 626 of the second signal terminal S2 have the same structure and are coupled through narrow sides. The first extension surface 6242a of the first signal terminal S1 adjacent to the torsion portion 625 of the first signal terminal S1, and the second extension surface 6242b of the second signal terminal S2 adjacent to the torsion portion 625 of the second signal terminal S2 are coupled through wide sides. This arrangement is beneficial to tightly couple the first signal terminal S1 and the second signal terminal S2 in the signal terminal pair, thereby stabilizing the insertion loss and improving the signal transmission quality of the signal terminal pair.

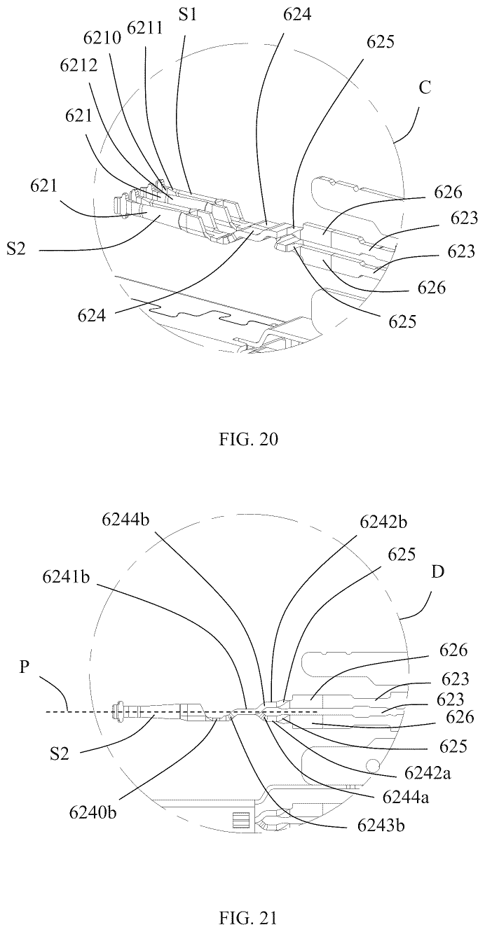

Referring to FIG. 20, in the illustrated embodiment of the present disclosure, each contact portion 621 of the signal terminal S has a two-half configuration. In the same signal terminal pair, the contact portion 621 of the first signal terminal S1 and the contact portion 621 of the second signal terminal S2 are the same so as to reduce cost. Hereinafter, only the contact portion 621 of the first signal terminal S1 is taken as an example for description.

The contact portion 621 of the first signal terminal S1 includes a first contact arm 6211, a second contact arm 6212 opposite to the first contact arm 6211, and a first clamping space 6210 located between the first contact arm 6211 and the second contact arm 6212. The first contact arm 6211 and the second contact arm 6212 are formed by bending two opposite edges of the first signal terminal S1 to the same side (i.e., a bottom-to-top side). The first contact arm 6211 and the second contact arm 6212 are disposed symmetrically at opposite sides of the first clamping space 6210.

When a needle-shaped signal terminal of the mating backplane connector 100 is inserted into the first clamping space 6210, the first contact arm 6211 and the second contact arm 6212 can be elastically deformed so as to improve contact reliability.

Each contact portion 621 of the first ground terminal G1 and the second ground terminal G2 is substantially flat. The contact portion 621 of the first ground terminal G1, the contact portion 621 of the second ground terminal G2, and the connection portions 623 of the conductive terminals 62 are all coplanar. The contact portion 621 of the first ground terminal G1 and the contact portion 621 of the second ground terminal G2 both extend into the corresponding grooves 6122 to facilitate contact with the first metal shield 63 and the second metal shield 64. The contact portions 621 of the signal terminals S extend beyond the protruding block 6121.

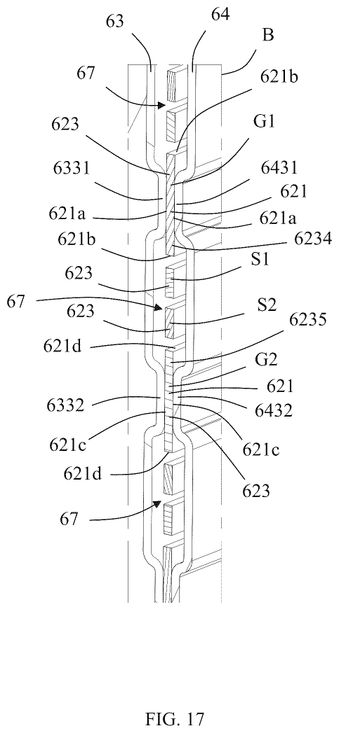

Referring to FIGS. 16 and 17, in the illustrated embodiment of the present disclosure, the contact portion 621 and the connection portion 623 of the first ground terminal G1 both include a first wide surface 621a and a first narrow surface 621b perpendicular to the first wide surface 621a. The contact portion 621 and the connection portion 623 of the second ground terminal G2 both include a second wide surface 621c and a second narrow surface 621d perpendicular to the second wide surface 621c. The connection portions 623 of each signal terminal pair are located between the first narrow surface 621b of the first ground terminal G1 and the second narrow surface 621d of the second ground terminal G2 which are located on opposite sides of the connection portions 623 of each signal terminal pair.

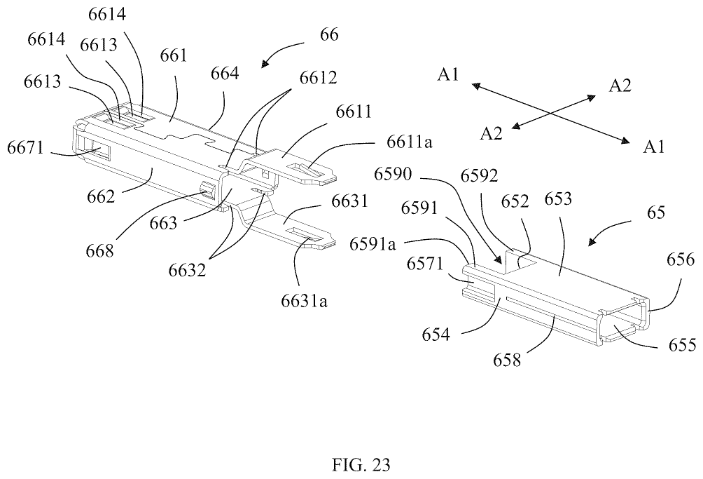

Referring to FIGS. 18, 19 and 23, each group of terminal modules 6 further includes an insulating block 65 sleeved on the contact portions 621 of the signal terminals S, and a metal shield surrounding member 66 sleeved on the insulating block 65. In the illustrated embodiment of the present disclosure, the contact portion 621 of the signal terminal S is located in the insulating block 65. The insulating block 65 does not fix the contact portion 621 of the signal terminal S. In other words, the contact portion 621 of the signal terminal S is deformable to a certain extent in the insulating block 65 when the mating terminal is inserted. Each insulating block 65 includes an end surface 652, a terminal receiving hole 650 extending through the end surface 652, a first extension block 6591 protruding from the end surface 652 and located on one side of the insulating block 65, and a second extension block 6592 protruding from the end surface 652 and located on another side of the insulating block 65. The insulating block 65 further defines an accommodating space 6590 between the first extension block 6591 and the second extension block 6592. The first extension block 6591 is provided with a first mating surface 6591a. The second extension block 6592 is provided with a second mating surface 6592a. In the illustrated embodiment of the present disclosure, the insulating block 65 is generally in the shape of a rectangular parallelepiped, and includes a first side 653, a second side 654, a third side 655 and a fourth side 656 which are connected in sequence. The first side 653 is opposite to the third side 655. The second side 654 is opposite to the fourth side 656. The first extension block 6591 and the second extension block 6592 are provided on the second side 654 and the fourth side 656, respectively. The first extension block 6591 defines a first limiting groove 6571 extending through the first mating surface 6591a. The second extension block 6592 defines a second limiting groove 6572 extending through the second mating surface 6592a. The second side 654 and the fourth side 656 are respectively provided with ribs 658 located behind the first limiting groove 6571 and the second limiting groove 6572.

The metal shield surrounding member 66 is substantially cuboid shaped. In an embodiment of the present disclosure, the insulating block 65 is fixed in the metal shield surrounding member 66 by soldering. Of course, in other embodiments, the insulating block 65 may also be fixed in the metal shield surrounding member 66 in other ways.

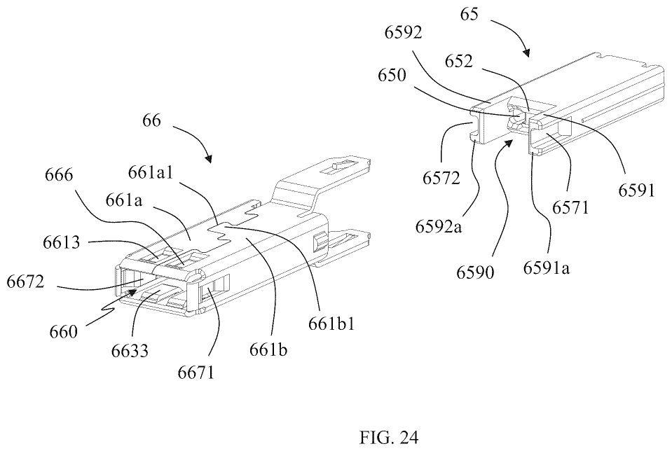

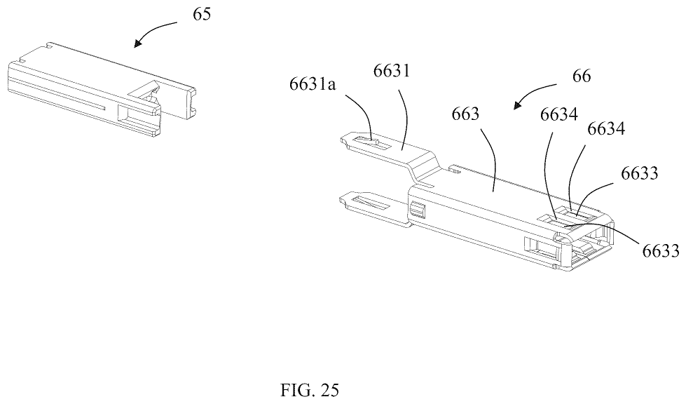

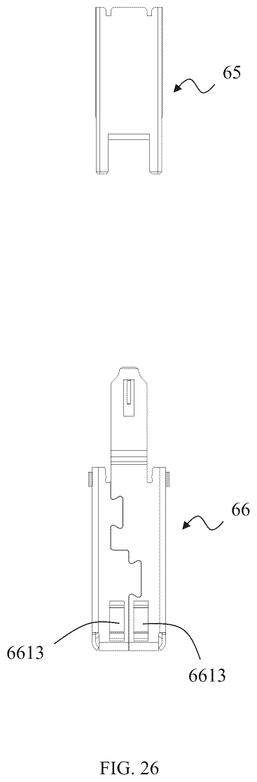

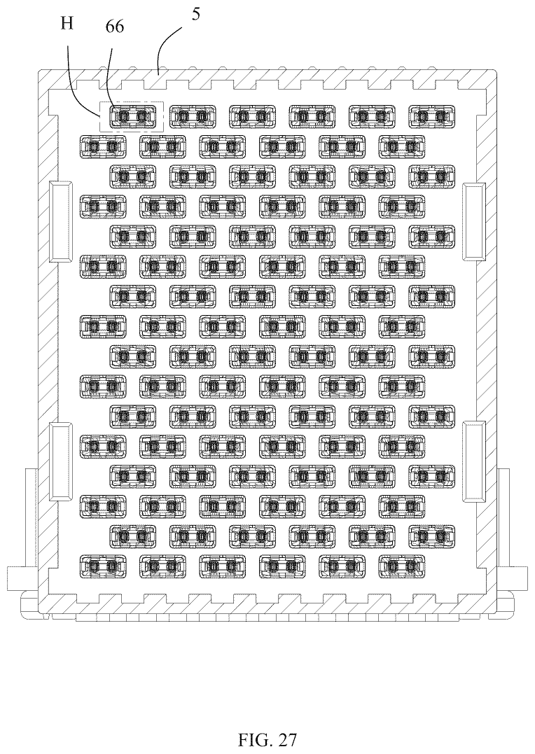

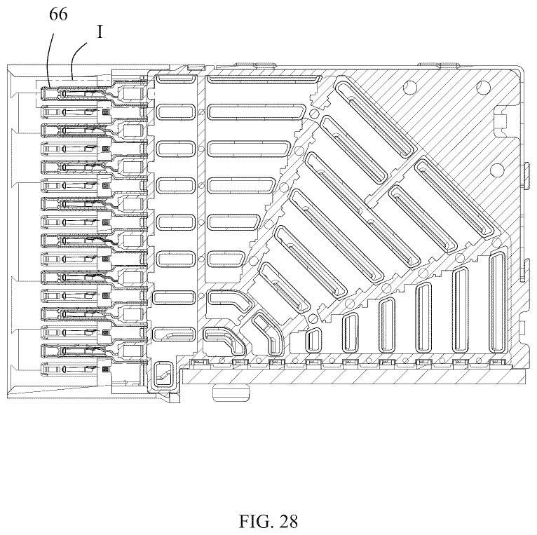

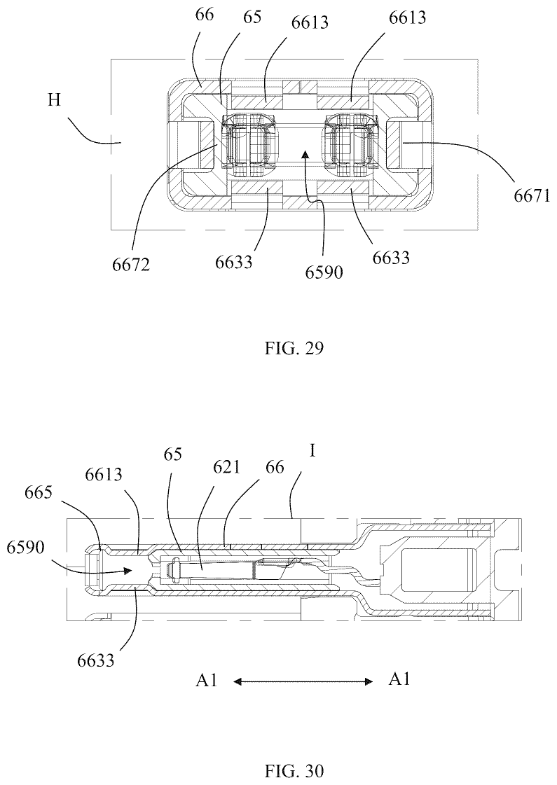

Referring to FIG. 10 and FIGS. 23 to 30, the metal shield surrounding member 66 includes a first side wall 661, a second side wall 662, a third side wall 663 and a fourth side wall 664. The first side wall 661 is opposite to the third side wall 663. The second side wall 662 is opposite to the fourth side wall 664. The metal shield surrounding member 66 includes an inner cavity 660 enclosed by the first side wall 661, the second side wall 662, the third side wall 663 and the fourth side wall 664. In the illustrated embodiment of the present disclosure, the first side wall 661, the second side wall 662, the third side wall 663 and the fourth side wall 664 are formed by stamping, bending and buckling a metal plate. The first side wall 661, the second side wall 662, the third side wall 663 and the fourth side wall 664 respectively correspond to the first side 653, the second side 654, the third side 655 and the fourth side 656 of the insulating block 65. An area of either of the first side wall 661 and the third side wall 663 is larger than an area of either of the second side wall 662 and the fourth side wall 664. The ends of the first side wall 661, the second side wall 662, the third side wall 663 and the fourth side wall 664 all include a deflection portion 665 which is bent inwardly. By providing the deflection portions 665, a constricted portion can be formed at an end of the metal shield surrounding member 66, so that outer surfaces 6651 of the deflection portions 665 can guide the terminal module 6 to be assembled to the header 5, and even guide the metal shield surrounding member 66 to be inserted into the mating backplane connector 100. Besides, the second side wall 662 and the fourth side wall 664 are respectively provided with a first bulge 6671 and a second bulge 6672 formed by stamping inwardly. The second side wall 662 and the fourth side wall 664 are respectively provided with raised portions 668 formed by stamping outwardly. The first bulge 6671 and the second bulge 6672 protrude into the inner cavity 660. When the metal shield surrounding member 66 and the insulating block 65 are assembled, the first bulge 6671 and the second bulge 6672 respectively extend into corresponding first limiting groove 6571 and the second limiting groove 6572, respectively, to achieve position limiting. When the metal shield surrounding member 66 and the insulating block 65 are assembled in place, the ribs 658 of the second side 654 and the fourth side 656 abut against the second side wall 662 and the fourth side wall 664, respectively, to improve the holding force. Besides, the first bulge 6671 and the second bulge 6672 abut against the rear ends of the corresponding first limiting groove 6571 and the second limiting groove 6572, respectively, to limit the relative position between the metal shield surrounding member 66 and the insulating block 65. In the illustrated embodiment of the present disclosure, the first bulge 6671 and the second bulge 6672 are fixed in the corresponding first limiting groove 6571 and the second limiting groove 6572, respectively. The first bulge 6671 and the second bulge 6672 are blocked by the first extension block 6591 and the second extension block 6592 of the insulating block 65, respectively, so as not to be exposed to the inner cavity 660. When the signal terminals of the mating backplane connector 100 are separated from the contact portions 621 of the signal terminal pairs, the signal terminals of the mating backplane connector 100 will pass through the first extension block 6591 and the second extension block 6592 along the first direction A1-A1. At this time, the first extension block 6591 and the second extension block 6592 are able to reduce the degree of change in dielectric constant caused by the air medium surrounding the signal terminal pair, thereby playing a role of adjusting impedance. The raised portion 668 abuts against the inner wall of the body potion 51 where the terminal receiving grooves 511 are formed to increase the holding force. In one embodiment of the present disclosure, the raised portion 668 abuts against a stopping wall on the inner wall of the body potion 51 to limit the terminal module 6 when it is assembled to the header 5.

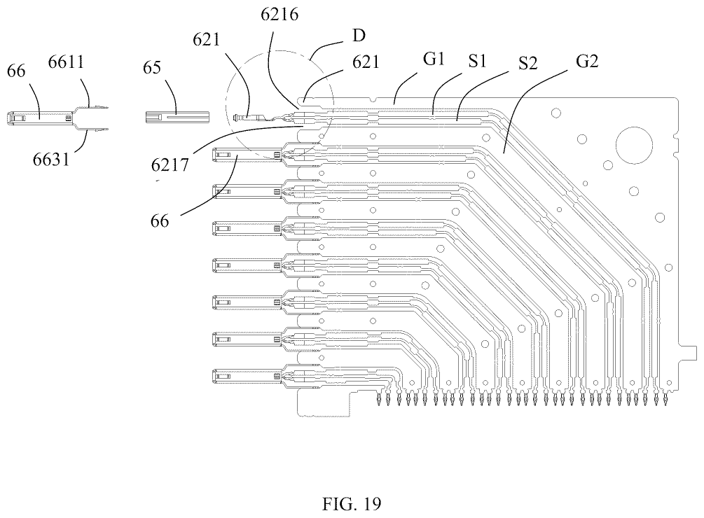

In the illustrated embodiment of the present disclosure, the metal shield surrounding member 66 further includes a first extension piece 6611 extending from the first side wall 661 and a pair of first slots 6612 located on opposite sides of the first extension piece 6611. The metal shield surrounding member 66 further includes a second extension piece 6631 extending from the third side wall 663 and a pair of second slots 6632 located on opposite sides of the second extension piece 6631. The first extension piece 6611 is in vertical contact with the contact portion 621 of the first ground terminal G1 so as to improve the shielding effect. The second extension piece 6631 is in vertical contact with the contact portion 621 of the second ground terminal G2 so as to improve the shielding effect. In the illustrated embodiment of the present disclosure, the first extension piece 6611 and the second extension piece 6631 are deflected outwardly and then extend, so that a distance between the first extension piece 6611 and the second extension piece 6631 on the same metal shield surrounding member 66 is greater than a distance between the first side wall 661 and the third side wall 663. Referring to FIG. 19, for a group of conductive terminals 62 disposed in the manner of G1-S1-S2-G2, the contact portion 621 of the first ground terminal G1 includes a first notch 6216 adjacent to the signal terminal pair. The first notch 6216 is used for receiving the first extension piece 6611. The contact portion 621 of the second ground terminal G2 includes a second notch 6217 adjacent to the signal terminal pair. The second notch 6217 is used for receiving the second extension piece 6631. In the illustrated embodiment of the present disclosure, taking two adjacent pairs of signal terminal pair sharing one second ground terminal G2 as an example, two sides of the second ground terminal G2 respectively include second notches 6217 facing different signal terminal pair, and the second notches 6217 are used for mating with two adjacent metal shield surrounding members 66. The first extension piece 6611 includes a first inclined tab 6611a stamped outwardly (for example, upwardly). The second extension piece 6631 includes a second inclined tab 6631a stamped outwardly (for example, downwardly). In the illustrated embodiment of the present disclosure, the protruding directions of the first inclined tab 6611a and the second inclined tab 6631a are opposite. When the first extension piece 6611 is inserted into the first notch 6216 of the contact portion 621 of the first ground terminal G1, the first inclined tab 6611a is able to abut against the contact portion 621 of the first ground terminal G1 to improve contact reliability. Similarly, when the second extension piece 6631 is inserted into the second notch 6217 of the contact portion 621 of the second ground terminal G2, the second inclined tab 6631a is able to abut against the contact portion 621 of the second ground terminal G2 to improve contact reliability.

The metal shield surrounding member 66 is provided with at least one bump portion 666 protruding into the inner cavity 660 and exposed in the inner cavity 660. The bump portion 666 is configured to adjust the impedance so that the impedance is relatively stable. The bump portion 666 protrudes into the accommodating space 6590. The bump portion 666 and the contact portion 621 are spaced apart in the first direction A1-A1 and do not overlap in the first direction A1-A1. In other words, the location of the bump portion 666 will not affect the impedance of the contact portion 621.

In the illustrated embodiment of the present disclosure, the first side wall 661 is further provided with at least one first bump portion 6613 protruding into the inner cavity 660. The third side wall 663 is further provided with at least one second bump portion 6633 protruding into the inner cavity 660. The bump portion 666 includes the first bump portion 6613 and the second bump portion 6633.

In the illustrated embodiment of the present disclosure, two first bump portions 6613 are provided and spaced apart along the second direction A2-A2; and two second bump portions 6633 are provided and spaced apart along the second direction A2-A2. In the illustrated embodiment of the present disclosure, the first bump portions 6613 are stamped from the first side wall 661 into the inner cavity 660. The first side wall 661 is provided with two first depressions 6614 corresponding to the first bump portions 6613 that are left after the first bump portions 6613 are stamped. Similarly, the third side wall 663 is provided with two second depressions 6634 corresponding to the second bump portions 6633 that are left after the second bump portions 6633 are stamped. In the illustrated embodiment of the present disclosure, the first bump portions 6613 and the second bump portions 6633 are symmetrically disposed on two sides (for example, upper and lower sides) of the inner cavity 660.

In the illustrated embodiment of the present disclosure, the first side wall 661 includes a first riveting portion 661a and a second riveting portion 661b. The first riveting portion 661a and the second riveting portion 661b are provided with dovetail grooves 661a1 and dovetail protrusions 661b1 that are buckled together. One of the two first bump portions 6613 is provided on the first riveting portion 661a, and a remaining one of the two first bump portions 6613 is provided on the second riveting portion 661b. In the illustrated embodiment of the present disclosure, the first bump portions 6613 and the second bump portions 6633 are disposed adjacent to the deflection portions 665. In other words, the first bump portions 6613 and the second bump portions 6633 are disposed adjacent to an insertion opening of the inner cavity 660.

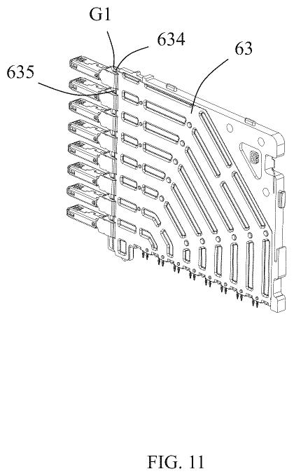

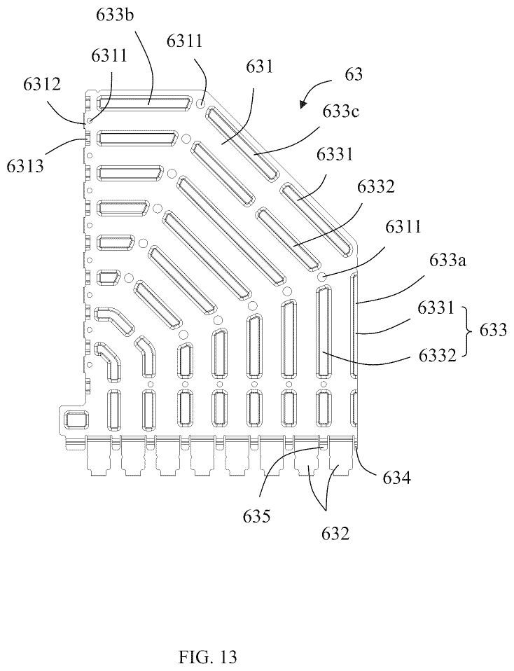

In the illustrated embodiment of the present disclosure, the first metal shield 63 and the second metal shield 64 are symmetrically disposed on both sides of the insulating frame 61. Referring to FIGS. 12 and 13, the first metal shield 63 includes a first main body portion 631, a first extension portion 632 extending from the first main body portion 631, and a first elastic arm 634 and a second elastic arm 635 which are respectively located on two sides of the first extension portion 632. The first elastic arm 634 and the second elastic arm 635 extend beyond the first main body portion 631 to contact the first ground terminal G1 and the second ground terminal G2, respectively. The first main body portion 631 is located on one side of the connection portion 623 of the conductive terminal 62. In the illustrated embodiment of the present disclosure, the first extension portion 632 and the first main body portion 631 are located in different planes, in which the first extension portion 632 is farther away from the second metal shield 64 than the first main body portion 631. The first main body portion 631 includes a plurality of first mounting holes 6311 for mating with the plurality of first posts 6161. The first posts 6161 are fixed to the first mounting holes 6311 by soldering. The first main body portion 631 includes a plurality of ribs 633. The ribs 633 include a plurality of first ribs 6331 protruding toward the first ground terminal G1 and a plurality of second ribs 6332 protruding toward the second ground terminal G2. The first ribs 6331 are disposed along an extending direction of the connection portion 623 of the first ground terminal G1. The second ribs 6332 are disposed along an extending direction of the connection portion 623 of the second ground terminal G2. In the illustrated embodiment of the present disclosure, the first ribs 6331 and the second ribs 6332 are formed by stamping the first main body portion 631. The first ribs 6331 and the second ribs 6332 protrude toward the second metal shield 64. The first ribs 6331 and the second ribs 6332 are disposed discontinuously along the extending direction of the connection portion 623 of the first ground terminal G1 and the extending direction of the connection portion 623 of the second ground terminal G2, respectively, so as to achieve multi-position contact. Therefore, the reliability of the contact between the first metal shield 63 and the first ground terminals G1 and the second ground terminals G2 is improved. In the illustrated embodiment of the present disclosure, a wall thickness of the first rib 6331, a wall thickness of the second rib 6332, and a wall thickness of a portion of the first main body portion 631 located between the first rib 6331 and the second rib 6332 are the same. Specifically, each of the first rib 6331 and the second rib 6332 includes a first rib section 633a parallel to the contact portion 621, a second rib section 633b parallel to the tail portion 622, and a third rib section 633c connecting the first rib section 633a and the second rib section 633b. Referring to FIG. 11, the first rib section 633a extends vertically, the second rib section 633b extends horizontally, and the third rib section 633c extends obliquely. The first rib section 633a, the second rib section 633b and the third rib section 633c correspondingly contact the first section 623a, the second section 623b and the third section 623c of the first ground terminal G1 and the second ground terminal G2, respectively.

In addition, the first main body portion 631 further includes a plurality of first protruding pieces 6312 extending downwardly from a bottom edge thereof and a plurality of connecting pieces 6313 each of which is located between two adjacent first protruding pieces 6312. By providing the first protruding pieces 6312, the shielding length can be extended, and the shielding effect on the signal terminals S can be improved. In the illustrated embodiment of the present disclosure, the connecting pieces 6313 are stamped from the first main body portion 631.

In the illustrated embodiment of the present disclosure, there are multiple first extension portions 632 which are disposed at intervals. The first extension portions 632 are used to be inserted into the first slots 6612 and the second slots 6632 of the metal shield surrounding member 66 to achieve contact and improve the shielding effect.

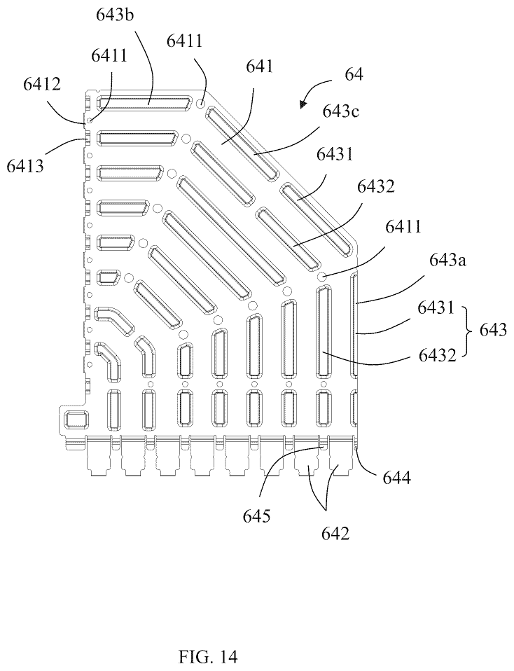

Similarly, referring to FIGS. 12 and 14, the second metal shield 64 includes a second main body portion 641, a second extension portion 642 extending from the second main body portion 641, and a third elastic arm 644 and a fourth elastic arm 645 which are respectively located on both sides of the second extension portion 642. The third elastic arm 644 and the fourth elastic arm 645 extend beyond the second main body portion 641 to contact the first ground terminal G1 and the second ground terminal G2, respectively. The second main body portion 641 is located on the other side of the connection portion 623 of the conductive terminal 62. In the illustrated embodiment of the present disclosure, the second extension portion 642 and the second main body portion 641 are located in different planes, in which the second extension portion 642 is farther away from the first metal shield 63 than the second main body portion 641. The second main body portion 641 includes a plurality of second mounting holes 6411 for mating with the plurality of second posts 6162. The second posts 6162 are fixed and positioned in the second mounting holes 6411 by soldering. The second main body portion 641 includes a plurality of ribs 643. The ribs 643 include a plurality of third ribs 6431 protruding toward the first ground terminal G1 and a plurality of fourth ribs 6432 protruding toward the second ground terminal G2. The third ribs 6431 are disposed along the extending direction of the connection portion 623 of the first ground terminal G1. The fourth ribs 6432 are disposed along the extending direction of the connection portion 623 of the second ground terminal G2. In the illustrated embodiment of the present disclosure, the third ribs 6431 and the fourth ribs 6432 are formed by stamping the second main body portion 641. The third ribs 6431 and the fourth ribs 6432 protrude toward the first metal shield 63. The third ribs 6431 and the fourth ribs 6432 are disposed discontinuously along the extending direction of the connection portion 623 of the first ground terminal G1 and the extending direction of the connection portion 623 of the second ground terminal G2, respectively, so as to achieve multi-position contact. Therefore, the contact reliability between the second metal shield 64 and the first ground terminals G1 and the second ground terminals G2 is improved. In the illustrated embodiment of the present disclosure, a wall thickness of the third rib 6431, a wall thickness of the fourth rib 6432, and a wall thickness of a portion of the second main body portion 641 located between the third rib 6431 and the fourth rib 6432 are the same. Specifically, each of the third rib 6431 and the fourth rib 6432 includes a fourth rib section 643a parallel to the contact portion 621, a fifth rib section 643b parallel to the tail portion 622, and a six rib section 643c connecting the fourth rib section 643a and the fifth rib section 643b. Referring to FIG. 14, the fourth rib section 643a extends vertically, the fifth rib section 643b extends horizontally, and the sixth rib section 643c extends obliquely. The fourth rib section 643a, the fifth rib section 643b and the sixth rib section 643c correspondingly contact the first section 623a, the second section 623b and the third section 623c of the first ground terminal G1 and the second ground terminal G2, respectively.

In an embodiment of the present disclosure, soldering is performed on the surfaces of the ribs 633 and the ribs 643 to solder the ribs 633 and the ribs 643 to the first ground terminals G1 and the second ground terminals G2. For example, soldering is performed on the surfaces of the first ribs 6331, the second ribs 6332, the third ribs 6431 and the fourth ribs 6432 so that the first ribs 6331, the second ribs 6332, the third ribs 6431 and the fourth ribs 6432 are soldered to the first ground terminals G1 and the second ground terminals G2. The soldering method is at least one of spot soldering, laser soldering and ultrasonic soldering.

In addition, the second main body portion 641 further includes a plurality of fourth protruding pieces 6412 extending downwardly from a bottom edge thereof, and a plurality of connecting pieces 6413 each of which is located between two adjacent fourth protruding pieces 6412. By providing the fourth protruding pieces 6412, the shielding length can be extended, and the shielding effect on the signal terminals S can be improved. In the illustrated embodiment of the present disclosure, the connecting pieces 6413 is stamped from the second main body portion 641.

In the illustrated embodiment of the present disclosure, there are multiple second extension portions 642 which are disposed at intervals. The second extension portions 642 are used to be inserted into the first slots 6612 and the second slots 6632 of the metal shield surrounding member 66 so as to achieve contact and improve the shielding effect.

Referring to FIG. 17, in the length of the connection portion 623 of the conductive terminal 62, the first rib 6331 of the first metal shield 63 and the third rib 6431 of the second metal shield 64 are in contact with two opposite side surfaces of the connection portion 623 of the first ground terminal G1, respectively. The second rib 6332 of the first metal shield 63 and the fourth rib 6432 of the second metal shield 64 are in contact with two opposite side surfaces of the connection portion 623 of the second ground terminal G2, respectively. As a result, a shielding cavity 67 surrounding the outer periphery of the connection portion 623 of each signal terminal pair is formed. In the illustrated embodiment of the present disclosure, the first rib 6331 and the third rib 6431 contact the first wide surface 621a of the connection portion 623 of the first ground terminal G1, respectively. The second rib 6332 and the fourth rib 6432 contact the second wide surface 621c of the connection portion 623 of the second ground terminal G2, respectively. In the illustrated embodiment of the present disclosure, the shielding cavity 67 is formed by the first main body portion 631, the second main body portion 641, the first ground terminal G1 and the second ground terminal G2. The connection portion 623 of the first ground terminal G1 includes a first tab portion 6234 extending into the shielding cavity 67. The connection portion 623 of the second ground terminal G2 includes a second tab portion 6235 extending into the shielding cavity 67. The connection portions 623 of the signal terminal pair are located between the first tab portion 6234 and the second tab portion 6235. In the illustrated embodiment of the present disclosure, there are a plurality of shielding cavities 67 which are disposed along an arrangement direction of each group of the conductive terminals 62. Two adjacent shielding cavities 67 share a single first ground terminal G1 or a single second ground terminal G2. Taking the shared first ground terminal G1 as an example, a part of the shared first ground terminal G1 protrudes into one shielding cavity 67, and another part of the shared first ground terminal G1 protrudes into another shielding cavity 67.

At a position adjacent to the contact portion 621 of the conductive terminal 62, the first extension portion 632 and the second extension portion 642 are both inserted into the first slot 6612 and the second slot 6632 of the metal shield surrounding member 66. The first extension piece 6611 and the second extension piece 6631 of the metal shield surrounding member 66 are respectively inserted into the first notch 6216 of the first ground terminal G1 and the second notch 6217 of the second ground terminal G2. At the same time, the first elastic arm 634 of the first metal shield 63 and the third elastic arm 644 of the second metal shield 64 clamp both sides of the contact portion 621 of the first ground terminal G1. The second elastic arm 635 of the first metal shield 63 and the fourth elastic arm 645 of the second metal shield 64 clamp both sides of the contact portion 621 of the second ground terminal G2. Specifically, the first elastic arm 634 and the third elastic arm 644 clamp the first wide surface 621a of the first ground terminal G1. The second elastic arm 635 and the fourth elastic arm 645 clamp the second wide surface 621c of the second ground terminal G2. With this arrangement, the first metal shield 63, the second metal shield 64, the metal shield surrounding member 66, the first ground terminal G1, and the second ground terminal G2 are all connected in series, thereby the shielding area is increased and the shielding effect is improved.

In the illustrated embodiment of the present disclosure, there are multiple terminal modules 6 of the backplane connector 200, and the terminal arrangement of two adjacent terminal modules 6 are staggered. Correspondingly, the shielding cavities 67 of two adjacent terminal modules 6 are also staggered. When the terminal module 6 is assembled to the header 5, the metal shield surrounding member 66 of the terminal module 6 passes through the corresponding terminal receiving grooves 511 so as to extend into the receiving space 535.

Compared with the prior art, the metal shield surrounding member 66 of the present disclosure is provided with at least one bump portion 666 protruding into the inner cavity 660 and exposed to the inner cavity 660. The bump portion 666 is configured to adjust the impedance of the signal terminal pair. When the signal terminals of the mating backplane connector 100 are separated from the contact portions 621 of the signal terminal pair, the signal terminals of the mating backplane connector 100 will pass through the bump portion 666 along the first direction A1-A1. At this time, the bump portion 666 is able to suppress the impedance of the signal terminal, thereby playing a role of adjusting the impedance.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A terminal module, comprising:
a plurality of conductive terminals, each conductive terminal comprising a contact portion; the plurality of conductive terminals comprising a first signal terminal and a second signal terminal, the first signal terminal and the second signal terminal forming a signal terminal pair;
an insulating block, the insulating block being sleeved on the contact portion of the first signal terminal and the contact portion of the second signal terminal; and
a metal shield surrounding member, the metal shield surrounding member being sleeved on the insulating block; the metal shield surrounding member comprising a first side wall, a second side wall, a third side wall and a fourth side wall; the first side wall being opposite to the third side wall; the second side wall being opposite to the fourth side wall; the metal shield surrounding member defining an inner cavity surrounded by the first side wall, the second side wall, the third side wall and the fourth side wall; the insulating block being at least partially received in the inner cavity;
wherein the metal shield surrounding member is provided with at least one bump portion protruding into the inner cavity and exposed in the inner cavity; the bump portion is configured to adjust impedance of the signal terminal pair.

2. The terminal module according to claim 1, wherein the contact portion extends along a first direction; the bump portion and the contact portion are spaced apart in the first direction and do not overlap in the first direction.

3. The terminal module according to claim 1, wherein the bump portion comprises at least one first bump portion stamped from the first side wall into the inner cavity and at least one second bump portion stamped from the third side wall into the inner cavity.

4. The terminal module according to claim 3, wherein two first bump portions are provided and spaced apart along a second direction;
wherein two second bump portions are provided and spaced apart along the second direction; and
wherein the second direction is perpendicular to the first direction.

5. The terminal module according to claim 1, wherein the insulating block comprises a first side, a second side, a third side and a fourth side; the first side is opposite to the third side; the second side is opposite to the fourth side;
the first side wall, the second side wall, the third side wall and the fourth side wall shield the first side, the second side, the third side and the fourth side, respectively;
the second side defines a first limiting groove, the fourth side defines a second limiting groove; the second side wall comprises a first bulge formed by stamping inwardly; the fourth side wall comprises a second bulge formed by stamping inwardly; the first bulge is fixed in the first limiting groove; the second bulge is fixed in the second limiting groove; the first bulge and the second bulge are blocked by the insulating block so as not to be exposed in the inner cavity.

6. The terminal module according to claim 5, wherein the insulating block comprises an end surface, a terminal receiving hole extending through the end surface, a first extension block protruding beyond the end surface and located on one side of the insulating block, and a second extension block protruding beyond the end surface and located on another side of the insulating block;
the contact portion of the first signal terminal and the contact portion of the second signal terminal are received in the terminal receiving hole;
the first extension block comprises a first mating surface; the second extension block comprises a second mating surface; the first limiting groove is provided on the first extension block and extends through the first mating surface; the second limiting groove is provided on the second extension block and extends through the second mating surface.

7. The terminal module according to claim 1, wherein each end of the first side wall, the second side wall, the third side wall and the fourth side wall comprises a deflection portion bent inwardly; the deflection portions of the first side wall, the second side wall, the third side wall and the fourth side wall are spaced apart from one another; the deflection portions are configured to guide insertion of the metal shield surrounding member into a mating backplane connector.

8. The terminal module according to claim 1, wherein each conductive terminal comprises a connection portion connected to the contact portion; the plurality of conductive terminals comprise a first ground terminal and a second ground terminal; the signal terminal pair is located between the first ground terminal and the second ground terminal;
the terminal module further comprises an insulating bracket in which the connection portions of the conductive terminals are fixed; the insulating bracket defines a hollow portion in which the connection portions of the conductive terminals are partially exposed;
the metal shield surrounding member is in contact with the first ground terminal and/or the second ground terminal.

9. The terminal module according to claim 8, wherein the metal shield surrounding member comprises a first extension piece extending from the first side wall and a second extension piece extending from the third side wall; a distance between the first extension piece and the second extension piece is greater than a distance between the first side wall and the third side wall; the first extension piece is in contact with the contact portion of the first ground terminal in a perpendicular manner; the second extension piece is in contact with the contact portion of the second ground terminal in a perpendicular manner.

10. The terminal module according to claim 9, wherein the terminal module comprises a first metal shield located on one side of the insulating bracket and a second metal shield located on another side of the insulating bracket; the first metal shield comprises a first main body portion located on one side of the connection portions of the conductive terminals; the second metal shield comprises a second main body portion located on another opposite side of the connection portions of the conductive terminals;
the first main body portion comprises a first rib protruding toward the first ground terminal and a second rib protruding toward the second ground terminal;
the second main body portion comprises a third rib protruding toward the first ground terminal and a fourth rib protruding toward the second ground terminal;
the first rib and the third rib are in contact with two opposite side surfaces of the connection portion of the first ground terminal, respectively; the second rib and the fourth rib are in contact with two opposite side surfaces of the connection portion of the second ground terminal, respectively;
the first main body portion, the second main body portion, the first ground terminal and the second ground terminal are enclosed to form a shielding cavity that accommodates the connection portions of the signal terminal pair.

11. The terminal module according to claim 10, wherein the first metal shield comprises a first extension portion extending from the first main body portion; the second metal shield comprises a second extension portion extending from the second main body portion;
the metal shield surrounding member defines two first slots respectively located on two sides of the first extension piece and two second slots respectively located on two sides of the second extension piece;
the first extension portion is inserted into one of the first slots and one of the second slots of the metal shield surrounding member; the second extension portion is inserted into a remaining one of the first slots and a remaining one of the second slots of the metal shield surrounding member.

12. The terminal module according to claim 9, wherein the first extension piece comprises a first inclined tab formed by stamping; the second extension piece comprises a second inclined tab formed by stamping; the first inclined tab abuts against the contact portion of the first ground terminal; the second inclined tab abuts against the contact portion of the second ground terminal.

13. The terminal module according to claim 6, wherein the insulating block comprises an accommodating space between the first extension block and the second extension block; the bump portion protrudes into the accommodating space.

14. A backplane connector, comprising:
a header, the header defining a receiving space configured to receive a mating backplane connector and a plurality of terminal receiving grooves which extend through the header and communicate with the receiving space; and
a plurality of terminal modules assembled to the header; at least one of the terminal modules comprising:
a plurality of conductive terminals, each conductive terminal comprising a contact portion; the plurality of conductive terminals comprising a first signal terminal and a second signal terminal, the first signal terminal and the second signal terminal forming a signal terminal pair;
an insulating block, the insulating block being at least partially shielding the contact portion of the first signal terminal and the contact portion of the second signal terminal; and
a metal shield surrounding member, the metal shield surrounding member being at least partially shielding the insulating block; the metal shield surrounding member comprising a first side wall, a second side wall, a third side wall and a fourth side wall; the first side wall being opposite to the third side wall; the second side wall being opposite to the fourth side wall; the metal shield surrounding member defining an inner cavity enclosed by the first side wall, the second side wall, the third side wall and the fourth side wall; the insulating block being at least partially received in the inner cavity;
wherein the metal shield surrounding member is provided with at least one bump portion protruding into the inner cavity and exposed in the inner cavity; the bump portion is configured to adjust impedance of the signal terminal pair;
wherein the metal shield surrounding member passes through a corresponding terminal receiving groove so as to extend into the receiving space.

15. The backplane connector according to claim 14, wherein the contact portion extends along a first direction; the bump portion and the contact portion are spaced apart in the first direction and do not overlap in the first direction.

16. The backplane connector according to claim 14, wherein the bump portion comprises at least one first bump portion stamped from the first side wall into the inner cavity and at least one second bump portion stamped from the third side wall into the inner cavity.

17. The backplane connector according to claim 16, wherein two first bump portions are provided and spaced apart along a second direction;
wherein two second bump portions are provided and spaced apart along the second direction; and
wherein the second direction is perpendicular to the first direction.

18. The backplane connector according to claim 14, wherein the insulating block comprises a first side, a second side, a third side and a fourth side; the first side is opposite to the third side; the second side is opposite to the fourth side;
the first side wall, the second side wall, the third side wall and the fourth side wall shield the first side, the second side, the third side and the fourth side, respectively;
the second side defines a first limiting groove, the fourth side defines a second limiting groove; the second side wall comprises a first bulge formed by stamping inwardly; the fourth side wall comprises a second bulge formed by stamping inwardly; the first bulge is fixed in the first limiting groove; the second bulge is fixed in the second limiting groove; the first bulge and the second bulge are blocked by the insulating block so as not to be exposed in the inner cavity.

19. The backplane connector according to claim 18, wherein the insulating block comprises an end surface, a terminal receiving hole extending through the end surface, a first extension block protruding beyond the end surface and located on one side of the insulating block, and a second extension block protruding beyond the end surface and located on another side of the insulating block;
the contact portion of the first signal terminal and the contact portion of the second signal terminal are received in the terminal receiving hole;
the first extension block comprises a first mating surface; the second extension block comprises a second mating surface; the first limiting groove is provided on the first extension block and extends through the first mating surface; the second limiting groove is provided on the second extension block and extends through the second mating surface.

20. The backplane connector according to claim 14, wherein each end of the first side wall, the second side wall, the third side wall and the fourth side wall comprises a deflection portion bent inwardly; the deflection portions of the first side wall, the second side wall, the third side wall and the fourth side wall are spaced apart from one another; the deflection portions are configured to guide insertion of the metal shield surrounding member into a mating backplane connector.
